(19) United States
(12) Patent Application Publication
(10) Pub. No.: US 2022/0290425 A1
(43) Pub. Date: Sep. 15, 2022

(54) COATED BUILDING PANELS

(71) Applicant: ARMSTRONG WORLD INDUSTRIES, INC., Lancaster, PA (US)

(72) Inventors: John E. HUGHES, Lincoln University, PA (US); Christian BUSQUE, Lititz, PA (US); Linzhu ZHANG, Pittsburgh, PA (US)

(21) Appl. No.: 17/690,481

(22) Filed: Mar. 9, 2022

Related U.S. Application Data
(60) Provisional application No. 63/160,090, filed on Mar. 12, 2021.

(51) Int. Cl. E04B 1/84; C09D 131/04; C09D 7/65; C09D 7/61; C08L 91/06

(52) U.S. Cl. CPC E04B 1/8409; C09D 131/04; C09D 7/65; C09D 7/61; C08L 91/06; E04B 2001/8457; C08K 3/013

(57) ABSTRACT

Described herein is a coated building panel comprising an acoustical body comprising a first major surface and a side surface that intersects the first major surface, a coating applied to the first major surface, the coating comprising a polymeric binder, a pigment, and a hydrophobic component present in an amount ranging from about 1.0 wt. % to about 8.0 wt. % based on the total weight of the coating; and wherein the pigment and polymeric binder are present in a weight ratio ranging from about 3.5:1 to about 6.5:1.

### CROSS-REFERENCE TO RELATED APPLICATIONS

The present application claims priority to U.S. Provisional Application No. 63/160,090, filed on Mar. 12, 2021, the entirety of the above application(s) is (are) incorporated herein by reference.

### BACKGROUND

Building systems that utilize building panels help control noise as well as enhance the aesthetic appeal of a room environment. However, such panels have a tendency to become dirty when handled by installers or when removed during routine maintenance of a plenum space. Previous attempts at imparting cleanability to such panels have been at either a detriment to the acoustical performance of such panels or at the detriment to efficiencies in manufacture of the panel.

Thus, a need exists for building panels that provide good wash/scrub performance without creating the difficulties with respect to manufacturing or sacrificing acoustical performance.

### BRIEF SUMMARY

According to some embodiments, the present invention is directed to a coated building panel comprising: an acoustical body comprising a first major surface and a side surface that intersects the first major surface; a coating applied to the first major surface, the coating comprising: a polymeric binder; a pigment; and a hydrophobic component present in an amount ranging from about 1.0 wt. % to about 8.0 wt. % based on the total weight of the coating; and wherein the pigment and polymeric binder are present in a weight ratio ranging from about 3.5:1 to about 6.5:1.

In other embodiments, the present invention includes a coated building panel comprising: an acoustical body comprising a first major surface and a side surface that intersects the first major surface; a coating applied to the first major surface, the coating comprising: a polymeric binder; a pigment; and a hydrophobic component; and wherein the coating occupies a first volume, and the pigment occupies a second volume that is equal to about 51% to about 78% of the first volume, and wherein the coated building panel exhibits an NRC value of at least 0.5.

Other embodiments of the present invention include a coated building panel comprising: an acoustical body comprising a first major surface and a side surface that intersects the first major surface; a coating applied to the first major surface, the coating comprising: a polymeric binder; a surfactant; a hydrophobic component; a pigment composition comprising a first pigment having a non-white color; and wherein the coating occupies a first volume, and the pigment composition occupies a second volume that is equal to about 51% to about 78% of the first volume.

Other embodiments of the present invention include a coated building panel having a first major exposed surface opposite a second major exposed surface, the coated building panel comprising: an acoustical body comprising a first major surface opposite a second major surface and a side surface that intersects the first major surface and the second major surface; a coating applied to the first major surface of the acoustical body, the coating having an upper surface opposite a lower surface, the coating comprising: a polymeric binder; a pigment; and a hydrophobic component; and wherein the hydrophobic component is present at the upper surface of the coating in a first concentration and the hydrophobic component is present at the lower surface of the coating at a second concentration, the first concentration being greater than the second concentration.

Other embodiments of the present invention include a building system comprising a support grid; at least one of the aforementioned building panel; and wherein the building panel is supported by the support frame.

In other embodiments, the present invention includes a coating composition comprising: a liquid carrier; a solid blend comprising: a polymeric binder; a pigment; and a hydrophobic component present in an amount ranging from about 1 wt. % to about 8 wt. % based on the total weight of the solid blend; and wherein the pigment and binder are present in a weight ratio of at least about 3:1.

Other embodiments of the present invention include a coating composition comprising: a liquid carrier; a solid blend comprising: a polymeric binder having a Tg of at least about 20° C.; a pigment; and a hydrophobic component; and wherein the solid blend occupies a first volume, and the pigment occupies a second volume that is equal to about 51% to about 78% of the first volume.

In other embodiments, the present invention includes a method of creating an acoustical building panel comprising: a) applying the aforementioned coating composition to a first major surface of an acoustical body; and b) drying the coating composition at a drying temperature ranging from about 145° C. to about 250° C. for a drying period of time, thereby evaporating the liquid carrier from the coating composition to form a dry coating atop the acoustical body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a coated building panel according to the present invention;

FIG. 2 is a cross-sectional view of the coated building panel according to the present invention, the cross-sectional view being along the II line set forth in FIG. 1; and

FIG. 3 is a ceiling system comprising the coated building panel of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means+/−5% of the reference value. According to the present application, the term “substantially free” less than about 0.1 wt. % based on the total of the referenced value.

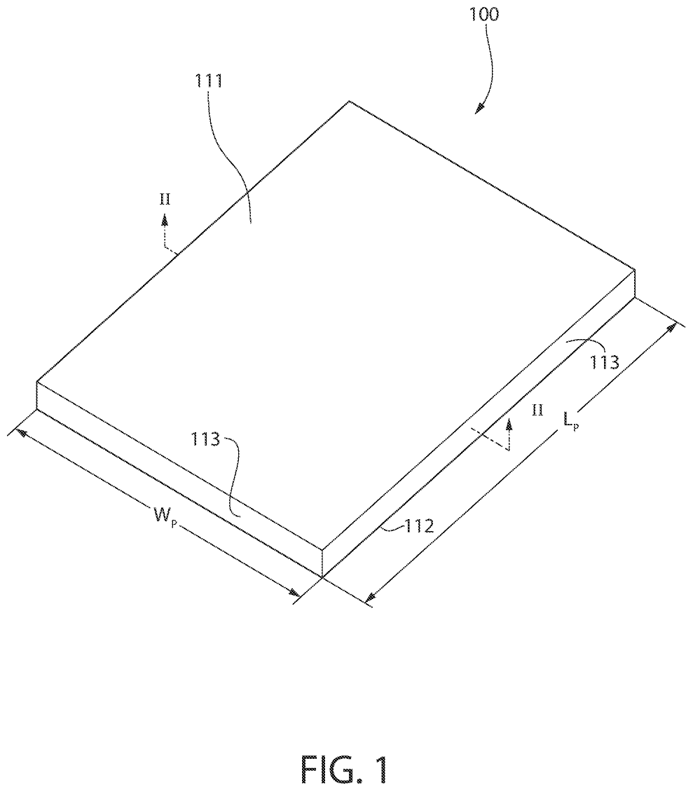

Referring to FIG. 1, the present invention includes a coated building panel 100 (referred to herein as “building panel”) comprising a first major exposed surface 111 opposite a second major exposed surface 112 and a side exposed surface 113 that extends between the first major exposed surface 111 and the second major exposed surface 112, thereby defining a perimeter of the ceiling panel 100.

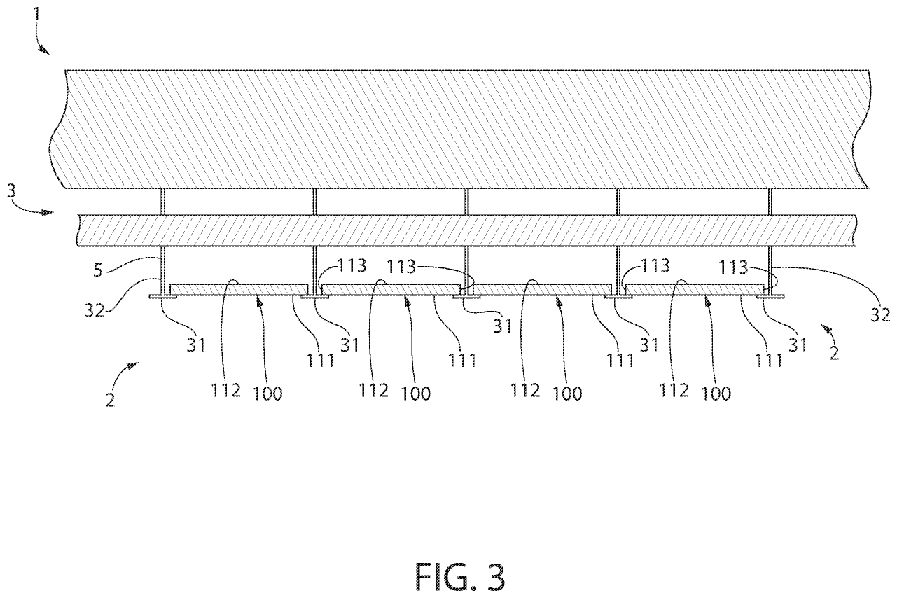

Referring to FIG. 3, the present invention may further include a building system 1 comprising one or more of the building panels 100 installed in an interior space. In the embodiments shown in FIG. 3, the building system 1 may be a ceiling system 1, whereby the interior space comprises a plenum space 3 and an active room environment 2. The plenum space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.).

According to the embodiments where there building system 1 is a ceiling system 1, in the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid 6. The plenum space 3 exists above the ceiling support grid 6 and the active room environment 2 exists below the ceiling support grid 6.

In the installed state, the first major surface 111 of the building panel 100 may face the active room environment 2 and the second major surface 112 of the building panel 100 may face the plenum space 3. According to the embodiments where there building system 1 is a ceiling system 1, the building panels 100 may be referred to as a ceiling panel 100.

Although not shown in FIG. 3, the building system 1 of the present invention may also be a wall system—whereby the building panels 100 are positioned on a vertical wall space within the interior space. According to the embodiments where there building system 1 is a wall system 1, the building panels 100 may be referred to as a wall panel.

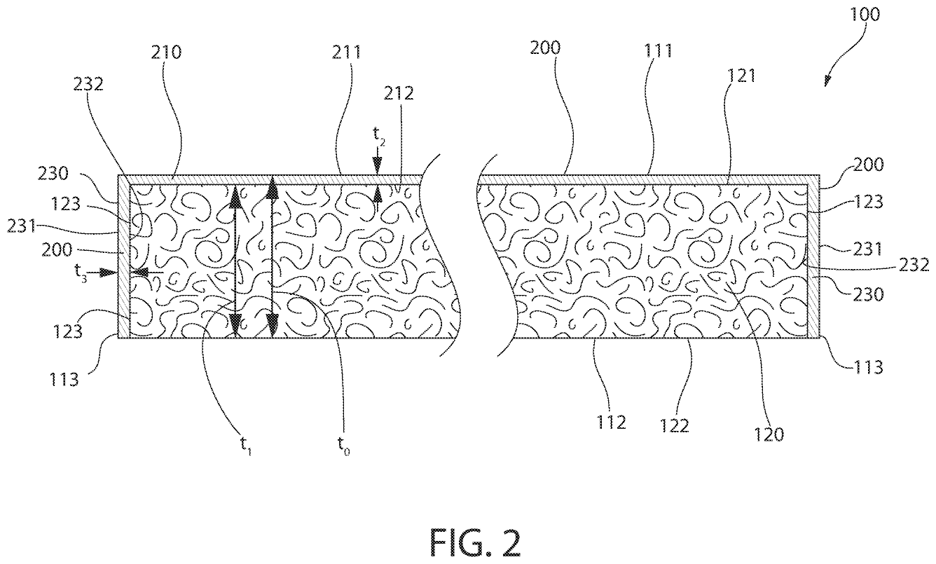

Referring now to FIGS. 1 and 2, the building panel 100 of the present invention may have a panel thickness to as measured from the first major exposed surface 111 to the second major exposed surface 112. The panel thickness to may range from about 12 mm to about 40 mm—including all values and sub-ranges there-between. The building panel 100 may have a length L_{P} ranging from about 30 cm to about 310 cm—including all values and sub-ranges there-between. The building panel 100 may have a width W_{P} ranging from about 10 cm to about 125 cm—including all values and sub-ranges there-between.

Referring now to FIG. 2, the building panel 100 may comprise a body 120 and a surface coating 200 applied thereto—as discussed further herein. The body 120 may comprise a binder and a fibrous component. In some embodiments, the body 120 may further comprise a filler and/or additive.

The body 120 comprises a first major surface 121 opposite a second major surface 122 and a body side surface 123 that extends between the first major surface 121 and the second major surface 122, thereby defining a perimeter of the body 120. The body 120 may have a body thickness t₁ that extends from the first major surface 121 to the second major surface 122. The body thickness t₁ may range from about 12 mm to about 40 mm—including all values and sub-ranges there-between.

The body 120 may be porous, thereby allowing airflow through the body 120 between the first major surface 121 and the second major surface 122—as discussed further herein. According to the present invention, the term porous refers to the body 120 being porous enough to allow for enough airflow through the body 120 (under atmospheric conditions) for the body 120 and the coated building panel 100 to function as an acoustic building panel 100 and for the corresponding building system 1 to function as an acoustic building system 1, which requires properties related to noise reduction and sound attenuation properties—as discussed further herein.

Specifically, the body 120 may have a porosity ranging from about 60% to about 98%—including all values and sub-ranges there between. In a preferred embodiment, the body 120 may have a porosity ranging from about 75% to 95%—including all values and sub-ranges there between.

According to the embodiments where the body 120 is formed from binder and fibers, porosity may be calculated by the following:

% Porosity=[V_{Total}−(V_{Binder}+V_{F}+V_{Filler})]/V_{Total}

Where V_{Total} refers to the total volume of the body 120 defined by the first major surface 121, the second major surface 122, and the side surfaces 123 of the body 120. V_{Binder} refers to the total volume occupied by the binder in the body 120. V_{F} refers to the total volume occupied by the fibrous component in the body 120. V_{Filler} refers to the total volume occupied by the filler and/or pigment in the body 120. Thus, the % porosity represents the amount of free volume within the body 120.

The body 120 of the present invention may exhibit sufficient airflow for the body 120—and resulting coated building panel 100—to have the ability to reduce the amount of reflected sound in an active room environment 2. The reduction in amount of reflected sound in an active room environment 2 is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The body 120 of the present invention exhibits an NRC of at least about 0.5. In a preferred embodiment, the body 120 of the present invention may have an NRC ranging from about 0.60 to about 0.99—including all value and sub-ranges there-between.

In addition to reducing the amount of reflected sound in a single active room environment 2, the body 120 may also be able to exhibit superior sound attenuation—which is a measure of the sound reduction between an active room environment 2 and a plenary space 3. The ASTM has developed test method E1414 to standardize the measurement of airborne sound attenuation between room environments 2 sharing a common plenary space 3. The rating derived from this measurement standard is known as the Ceiling Attenuation Class (CAC). Ceiling materials and systems having higher CAC values have a greater ability to reduce sound transmission through the plenary space 3—i.e. sound attenuation function.

The body 120 of the present invention may exhibit a CAC value of 30 or greater, preferably 35 or greater.

Non-limiting examples of binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The fibrous component may be selected from one or more of organic fibers, inorganic fibers, or a blend thereof. Non-limiting examples of inorganic fibers mineral wool (also referred to as slag wool), rock wool, stone wool, and glass fibers. Non-limiting examples of organic fiber include fiberglass, cellulosic fibers (e.g. paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof. In some embodiments, the body 120 may be a gypsum board—i.e., commonly referred to as “dry wall.”

The building panel 100 may further comprise the surface coating 200 applied to the body 120. The surface coating 200 may include a face coating 210 that is present atop the first major surface 121 of the body 120.

The surface coating 200 may comprise a binder, a hydrophobic component, a pigment, whereby the pigment imparts a desired aesthetic appearance, such as color. In some embodiments, the surfactant coating 200 may comprise other additives, such as flame retardants, defoamers, antimicrobial agents, thickeners, and other processing additives such as dispersants and wetting agents. In some embodiments, the surface coating 200 may be substantially free of ion exchange resins. In some embodiments, the surface coating 200 may be free of ion exchange resins.

Non-limiting examples of the binder of the surface coating 200 may include polymers selected from polyvinyl alcohol (PVOH), latex, an acrylic polymer, polymaleic anhydride, or a combination of two or more thereof. Non-limiting examples of latex binder may include a homopolymer or copolymer formed from the following monomers: vinyl acetate (i.e., polyvinyl acetate), vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and an ester.

In a non-limiting embodiment, the binder of the surface coating 200 is selected from polyvinyl acetate—including homopolymer of polyvinyl acetate and carboxylated polyvinyl acetate homopolymer.

The binder of the surface coating 200 may be a polymer that has a glass transition temperature (“Tg”) that is greater than about 20° C. The binder may be a polymer that has a glass transition temperature (“Tg”) that is greater than about 25° C. The binder may be a polymer that has a glass transition temperature (“Tg”) that is greater than about 30° C. The binder may be a polymer that has a glass transition temperature (“Tg”) that ranges from about 30° C. to about 40° C. The binder may be a polymer that has a glass transition temperature (“Tg”) that ranges from about 35° C. to about 40° C.

The binder of the surface coating 200 may be ionic. The binder of the surface coating 200 may be anionic. The binder of that has a glass transition temperature (“Tg”) that is greater than about 20° C. The binder may be a polymer that has a glass transition temperature (“Tg”) that is greater than about 25° C. The binder may be a polymer that has a glass transition temperature (“Tg”) that is greater than about 30° C. The binder may be a polymer that has a glass transition temperature (“Tg”) that ranges from about 30° C. to about 40° C. The binder may be a polymer that has a glass transition temperature (“Tg”) that ranges from about 35° C. to about 40° C.

The binder may be present in the surface coating 200 in an amount ranging from about 1 wt. % to about 50 wt. % based on the total dry-weight of the surface coating 200—including all amounts and sub-ranges there-between. In some embodiments, the binder may be present in the surface coating 200 in an amount ranging from about 5 wt. % to about 40 wt. % based on the total dry-weight of the surface coating 200—including all amounts and sub-ranges there-between. In some embodiments, the binder may be present in the surface coating 200 in an amount ranging from about 10 wt. % to about 30 wt. % based on the total dry-weight of the surface coating 200—including all amounts and sub-ranges there-between. In some embodiments, the binder may be present in the surface coating 200 in an amount ranging from about 10 wt. % to about 25 wt. % based on the total dry-weight of the surface coating 200—including all amounts and sub-ranges there-between.

In some embodiments, the binder may be present in the surface coating 200 in an amount ranging from about 15 wt. % to about 30 wt. % based on the total dry-weight of the surface coating 200—including all amounts and sub-ranges there-between. In some embodiments, the binder may be present in the surface coating 200 in an amount ranging from about 20 wt. % to about 30 wt. % based on the total dry-weight of the surface coating 200—including all amounts and sub-ranges there-between. In some embodiments, the binder may be present in the surface coating 200 in an amount ranging from about 20 wt. % to about 25 wt. % based on the total dry-weight of the surface coating 200—including all amounts and sub-ranges there-between. In some embodiments, the binder may be present in the surface coating 200 in an amount ranging from about 22 wt. % to about 24 wt. % based on the total dry-weight of the surface coating 200—including all amounts and sub-ranges there-between.

According to the present invention, the phrase “dry-state” indicates a composition that is substantially free of a liquid carrier (e.g., liquid water). Thus, the surface coating 200 in the dry-state may comprise pigment, binder, and other solid components, and have less than about 0.1 wt. % of liquid carrier based on the total weight of the surface coating 200. In a preferred embodiment, the surface coating 200 in the dry-state has a solid's content of about 100 wt. % based on the total weight of the surface coating 200. Conversely, a composition that is in a “wet-state,” which refers to a composition containing various amounts of liquid carrier—as discussed further herein.

As discussed, the surface coating 200 may comprise a hydrophobic component. The presence of the hydrophobic component in the surface coating 200 may result in the first major surface 111 of the building panel 100 having enhanced hydrophobicity.

According to the present invention, the term “hydrophobicity” or “hydrophobic” means a composition that is extremely difficult to wet and is capable of repelling liquid water under atmospheric conditions. Thus, as used herein, the term “hydrophobic” refers to a surface that generates a contact angle of greater than 900 with a reference liquid (i.e. water).

The notion of using the contact angle made by a droplet of liquid on a surface of a solid substrate as a quantitative measure of the wetting ability of the particular solid has also long been well understood. Wetting is the ability of a liquid to maintain contact with a solid surface, resulting from intermolecular interactions when the two are brought together. The degree of wetting (wettability) is determined by a force balance between adhesive and cohesive forces. If the contact angle is greater than 900 for the water droplet to the substrate surface then it is usually considered to be hydrophobic.

The first major surface 111 of the building panel 100 comprising the surface coating 200 may exhibits a water contact angle of at least about 90°. At this contact angle, most common waters and oils (e.g., fingerprint oils) will not wet the first major surface 111 of the building panel 100—thereby making the building panel 100 capable of washing and scrubbing performance while resistance to water—thereby providing for a way to continually clean the building panel 100 from an accumulated dirt or unwanted smudges.

Non-limiting examples of the hydrophobic component include waxes, silicones, fluoro-containing additives, and combinations thereof—as discussed further herein. The hydrophobic component may be applied as a water-based emulsion. The emulsion may be anionic or non-ionic. The emulsion may have a solid content (i.e., the amount of wax within the hydrophobic component) ranging from about 20 wt. % to about 60 wt. % based on the emulsion—including all value and sub-ranges there-between.

The hydrophobic component may have a melting temperature ranging between about 50° C. and about 70° C.—including all temperatures and sub-ranges there-between. The hydrophobic component may have a melting temperature ranging between about 55° C. and about 65° C.—including all temperatures and sub-ranges there-between. The hydrophobic component may have a melting temperature of about 60° C.

In some embodiments, the hydrophobic component is a wax. The wax may have a pH ranging from about 9.0 to about 11.0—including all values and sub-ranges there-between. In some embodiments, the wax may have a pH ranging from about 9.3 to about 10.5—including all values and sub-ranges there-between. In some embodiments, the wax may have a pH ranging from about 9.5 to about 10.3—including all values and sub-ranges there-between.

Non-limiting examples of wax include paraffin wax (i.e. petroleum derived wax), polyolefin wax, as well as naturally occurring waxes and blends thereof. Non-limiting examples of polyolefin wax include high density polyethylene (“HDPE”) wax, polypropylene wax, polybutene wax, polymethylpentene wax, and combinations thereof. Naturally occurring waxes may include plant waxes, animal waxes, and combination thereof. Non-limiting examples of animal waxes include beeswax, tallow wax, lanolin wax, animal fax based wax, and combinations thereof. Non-limiting examples of plant waxes include soy-based wax, carnauba wax, ouricouri wax, palm wax, candelilla wax, and combinations thereof. In a non-limiting embodiment, the wax is a blend of paraffin wax and HDPE wax.

The wax may be present in an amount ranging from about 0.5 wt. % to about 8 wt. % based on the total dry weight of the surface coating 200—including all percentages and sub-ranges there-between. In some embodiments, the wax is present in an amount ranging from about 1.0 wt. % to about 7.0 wt. % based on the total dry weight of the surface coating 200—including all percentages and sub-ranges there-between. In some embodiments, the wax is present in an amount ranging from about 1.5 wt. % to about 6.0 wt. % based on the total dry weight of the surface coating 200—including all percentages and sub-ranges there-between. In some embodiments, the wax is present in an amount ranging from about 2.0 wt. % to about 5.0 wt. % based on the total dry weight of the surface coating 200—including all percentages and sub-ranges there-between. In some embodiments, the wax is present in an amount ranging from about 2.5 wt. % to about 4.0 wt. % based on the total dry weight of the surface coating 200—including all percentages and sub-ranges there-between. In some embodiments, the wax is present in an amount ranging from about 2.5 wt. % to about 3.5 wt. % based on the total dry weight of the surface coating 200—including all percentages and sub-ranges there-between.

As discussed, the surface coating 200 may comprise a pigment. The presence of the pigment in the surface coating 200 may result in the first major surface 111 of the building panel 100 exhibiting a color. Stated otherwise, the presence of pigment may result in the surface coating 200 being a color coating. According to the present invention the term “color coating” and “surface coating” may be used interchangeably. The term “color coating” 200 refers to a surface coating 200 comprising a color pigment and the resulting surface coating 200 exhibits a color on the visible color spectrum—i.e., violet, blue, green, yellow, orange, or red. The color coating 200 may also have a color of white, black, or grey. The color coating 200 may further comprise combinations of two or more colors—such a primary color (i.e., red, yellow, blue) as well as an achromatic color (i.e., white, grey).

The term “white pigment” may refer to a pigment exhibiting a white color. The term “non-white pigment” may refer to a pigment exhibiting a color other than a white color—e.g., non-limiting examples of non-white pigment include pigments that exhibit violet, blue, green, yellow, orange, red, black, or grey.

The pigment may be present as a pigment composition comprising a blend of multiple pigments. In a non-limiting embodiment, the pigment composition may comprise a blend of first pigment and a second pigment. The first pigment may comprise the non-white pigment and the second pigment may comprise a white pigment. The first pigment may be present in an amount ranging from about 0.1 wt. % to about 10.0 wt. % based on the total weight of the coating composition in the dry state—including all percentages and sub-ranges there-between. In some embodiments, the first pigment may be present in an amount ranging from about 0.1 wt. % to about 2.0 wt. % based on the total weight of the coating composition in the dry state—including all percentages and sub-ranges there-between. The second pigment may be present in an amount ranging from about 60.0 wt. % to about 78.0 wt. % based on the total weight of the coating composition in the dry state—including all percentages and sub-ranges there-between.

The pigment composition may have a ratio of the second pigment to the white pigment that ranges from about 30:1 to about 70:1—including all ratios and sub-ranges there-between. The pigment composition may have a ratio of the second pigment to the white pigment that ranges from about 35:1 to about 60:1—including all ratios and sub-ranges there-between. The pigment composition may have a ratio of the second pigment to the white pigment that ranges from about 35:1 to about 55:1—including all ratios and sub-ranges there-between. The pigment composition may have a ratio of the second pigment to the white pigment that ranges from about 40:1 to about 55:1—including all ratios and sub-ranges there-between. The pigment composition may have a ratio of the second pigment to the white pigment that ranges from about 45:1 to about 55:1—including all ratios and sub-ranges there-between.

The pigment may be an inorganic pigment. Non-limiting examples of inorganic pigment include particles of carbon black, graphite, graphene, copper oxide, iron oxide, zinc oxide, calcium carbonate, manganese oxide, titanium dioxide, aluminum trihydrate, and combinations thereof. The inorganic pigments may include individual particles having colors selected from, but not limited to, red, blue, yellow, black, green, brown, violet, white, grey and combinations thereof. The particles that make up the pigment may have a particle size ranging from about 15 nm to about 1000 μm—including all sizes and sub-ranges there-between.

The pigment may be present in an amount ranging from about 60 wt. % to about 80 wt. % based on the total dry weight of the surface coating 200—including all percentages and sub-ranges there-between. In some embodiments, the pigment may be present in an amount ranging from about 62 wt. % to about 78 wt. % based on the total dry weight of the surface coating 200—including all percentages and sub-ranges there-between. In some embodiments, the pigment may be present in an amount ranging from about 66 wt. % to about 76 wt. % based on the total dry weight of the surface coating 200—including all percentages and sub-ranges there-between.

The surface coating 200 of the present invention may comprise an antimicrobial component. The antimicrobial component may be a component that imparts the antimicrobial activity to the resulting surface coating 200.

In a non-limiting embodiment, the antimicrobial agent may comprise a metal borate. The metal borate may be a compound corresponding to basic, dibasic, tribasic and polybasic metal borate(s), and mixtures thereof. For example, “zinc borate” refers to a group of compounds consisting zinc borate (ZnB₄O₇), any of the corresponding basic zinc borates (such as monobasic zinc borate of the structure Zn(OH)—B₄O₇, dibasic basic zinc borate of the structure 2Zn(OH)₂.B₄O₇, tribasic zinc borate of the structure 3Zn(OH)₃.B₄O₇ and the like), and mixtures thereof.

In a non-limiting embodiment, the antimicrobial agent may comprise a triazole compound. In a non-limiting embodiment, the antimicrobial agent may comprise a sulfur-containing benzimidazole compound. In some embodiments, the antimicrobial agent may comprise 2,2-dibromo-3 nitrilopropionamide (“DBNPA”).

The antimicrobial agent may be present in the protective coating 200 in an amount ranging from about 0.5 wt. % to about 10.0 wt. % based on the total dry-weight of the surface coating 200—including all wt. % and sub-ranges there-between. In some embodiments, the antimicrobial agent may be present in the surface coating 200 in an amount ranging from about 1.0 wt. % to about 9.0 wt. % based on the total dry-weight of the surface coating 200—including all wt. % and sub-ranges there-between. In some embodiments, the antimicrobial agent may be present in the surface coating 200 in an amount ranging from about 2.0 wt. % to about 9.0 wt. % based on the total dry-weight of the surface coating 200—including all wt. % and sub-ranges there-between. In some embodiments, the antimicrobial agent may be present in the surface coating 200 in an amount ranging from about 3.0 wt. % to about 9.0 wt. % based on the total dry-weight of the surface coating 200—including all wt. % and sub-ranges there-between. In some embodiments, the antimicrobial agent may be present in the surface coating 200 in an amount ranging from about 4.0 wt. % to about 8.0 wt. % based on the total dry-weight of the surface coating 200—including all wt. % and sub-ranges there-between.

The surface coating 200 may comprise a defoamer. Non-limiting examples of defoamer may include polyalphaolefin formed from one or more monomers of 1-hexene, 1-heptene, 1-octene, 1-nonene, 1-decene, 1-undecene, 1-tridecene, 1-tetradecene, 1-pentadecene, 1-hexadecene, 1-octadecene, 1-heptadecene, and 1-nonadecene; a high density polymer selected from oxidized ethylene homopolymers, polyethylene homopolymers, and polypropylene homopolymers; a silicone oil, polypropylene glycol, and diethylenetriamine; and a non-ionic surfactant compound selected from polyether modified polysiloxane, polyethylene glycol oleate, and polyoxypropylene-polyoxyethylene copolymer—as well as mixtures thereof.

The defoamer may be present in an amount ranging from about 0.01 wt. % to about 0.2 wt. % (including all values and sub-ranges there-between)—based on the total weight of the surface coating 200 in the dry-state. The defoamer may be present in an amount ranging from about 0.01 wt. % to about 0.1 wt. % (including all values and sub-ranges there-between)—based on the total weight of the surface coating 200 in the dry-state.

The surface coating 200 may further comprise a rheology agent. The term “rheology agent” refers to a component capable of modifying the rheological properties (e.g., viscosity) of the surface coating 200 in the wet-state. The rheology agent may be present in the surface coating 200 in an amount ranging from about 0.01 wt. % to about 0.5 wt. % based on the total dry-weight of the surface coating 200 including all wt. % and sub-ranges there-between. In some embodiments, the rheology agent may be present in the surface coating 200 in an amount ranging from about 0.05 wt. % to about 0.1 wt. % based on the total dry-weight of the surface coating 200—including all wt. % and sub-ranges there-between.

Non-limiting examples of rheology agent include thickeners. A non-limiting example of thickener includes natural cellulosics, e.g. hydroxyl ethyl cellulose-carboxymethyl cellulose, and polysaccharides. Inorganic thickeners, e.g. organoclay and hydrous magnesium aluminum-silicate. The synthetic thickeners, e.g. acrylic, HEUR, ASE,

The surface coating 200 may further comprise a stabilization agent that includes one or more of a dispersant, a wetting agent, or a combination thereof. The stabilization agent may be ionic in nature—i.e., comprise one or more ionic groups such as anionic group or cationic group. In a preferred embodiment, the stabilization agent may comprise an ionic group that is anionic.

The stabilization agent may be present in the surface coating 200 in an amount ranging from about 0.1 wt. % to about 2.0 wt. % based on the total dry-weight of the protective coating 200—including all wt % and sub-ranges there-between. In some embodiments, the stabilization agent may be present in the protective coating 200 in an amount ranging from about 0.1 wt. % to about 1.0 wt. % based on the total dry-weight of the protective coating 200—including all wt. % and sub-ranges there-between.

According to some embodiments, the stabilization agent may comprise an anionic polyacrylic polymer having a salt group formed from a neutralization of an acid group with a compound forming a cation. For examples, the polymer may comprise one or more pendant side chains comprising a terminal carboxylic acid group that is neutralized with sodium or ammonia to form a carboxylate anion and a sodium cation and/or ammonium cation. Alternatively, the polymer may comprise one or more pendant side chains comprising a terminal sulfonic acid group that is neutralized with the aforementioned sodium or ammonia compounds to form a salt group.

In other embodiments, the stabilization agent may be non-ionic. Non-limiting examples of non-ionic stabilization agents include, but at not limited to non-ionic alcohol ethoxylate surfactant. Other examples of ionic stabilization agents include, but at not limited to, phosphate polyether ionic surfactant.

The wetting agent is a type of surfactant that lowers the surface tension between two liquids or between a liquid and a solid. The wetting agent may comprise a hydrophobic portion and a hydrophilic portion. The hydrophobic portion may be a long aliphatic chain derived from a fatty alcohol. In other embodiments, the hydrophobic portion may comprise one or more aromatic groups. The wetting agent may be non-ionic, whereby the hydrophilic portion includes an ethoxylated chain. In a preferred embodiment, the wetting agent is non-ionic, whereby the hydrophobic portion comprises at least one aromatic group. The wetting agent may comprise two or more aromatic groups. Non-limiting examples of wetting agent include three aromatic groups, such as tristyrylphenol ethoxylate.

The surface coating 200, in the dry-state, may be present on one of the first major surface 121 of the body 120 in an amount ranging from about 11 g/ft² to about 17 g/ft²—including all amounts and sub-ranges there-between. In some embodiments, the surface coating 200, in the dry-state, may be present on one of the first major surface 121 of the body 120 in an amount ranging from about 12 g/ft² to about 16 g/ft²—including all amounts and sub-ranges there-between. In some embodiments, the surface coating 200, in the dry-state, may be present on one of the first major surface 121 of the body 120 in an amount ranging from about 13 g/ft² to about 15 g/ft²—including all amounts and sub-ranges there-between.

The surface coating 200, in the dry-state, present on the first major surface 121 of the body 120 may form a face coating 210. The lower surface 212 of the face coating 210 may be in direct contact with the upper surface 121 of the body 120. The upper surface 211 of the face coating 210 may form at least a portion of the first major surface 111 of the building panel 100—as discussed further herein. The first major surface 111 of the building panel 100 may comprise the upper surface 211 of the face coating 210.

The surface coating 200, may comprise the hydrophobic component at the upper surface 211 of the surface coating 200 in a first concentration. The surface coating 200, may comprise the hydrophobic component at the lower surface 212 of the surface coating 200 in a second concentration. The first concentration may be greater than the second concentration—herein referred to as a “concentration gradient” of the hydrophobic component. The surface coating 200 may be heterogeneous due to the concentration gradient of the hydrophobic component. The surface coating 200 may be heterogeneous with respect to the concentration gradient of the hydrophobic component while having a substantially uniform distribution of binder and pigment between the lower surface 212 and the upper surface 211 of the surface coating 200.

The surface coating 200 may be formed from a single application of a coating composition in the wet-state—as discussed further herein—whereby the single application of the coating composition in the wet-state is dried to form the concentration gradient of the hydrophobic component. The surface coating 200 may be free of interfaces between the lower surface 212 and the upper surface 211. The surface coating 200 may be free of discrete sub-layers between the lower surface 212 and the upper surface 211.

The surface coating 200, in the dry-state, present on the first major surface 121 of the body 120 may form a face coating 210. The lower surface 212 of the face coating 210 may be in direct contact with the upper surface 121 of the body 120. The upper surface 211 of the face coating 210 may form at least a portion of the first major surface 111 of the building panel 100—as discussed further herein. The first major surface 111 of the building panel 100 may comprise the upper surface 211 of the face coating 210.

The surface coating 200 may be a discontinuous coating. The term “discontinuous” refers to the surface coating 200 exhibiting at least a partial porosity that allows for airflow through the surface coating 200 under atmospheric conditions. Stated otherwise, the discontinuous nature of the surface coating 200 provides for pathways from upper surface 211 of the coating 200 to the lower surface 212 of the surface coating, the pathways allowing for air to flow through under atmospheric conditions. The discontinuous nature of the surface coating 200 provides for pathways that allow for air to flow from upper surface 211 of the coating 200 to the body 120.

The surface coating 200 may exhibit an airflow resistance ranging from about 70 MKS Rayls to about 95 MKS Rayls—including all airflow resistances and sub-ranges there-between. In some embodiments, the surface coating 200 may exhibit an airflow resistance ranging from about 75 MKS Rayls to about 90 MKS Rayls—including all airflow resistances and sub-ranges there-between.

With the body 120 being porous body, the combination of the surface coating 200 as a discontinuous coating and the body 120 may result in a building panel 100 that exhibits an NRC value of at least 0.5. In some embodiments, the combination of the surface coating 200 as a discontinuous coating and the body 120 being a porous body may result in the building panel 100 exhibiting an NRC vale that ranges from about 0.60 to about 0.99—including all value and sub-ranges there-between.

Although not shown, the building panel 100 of the present invention may further comprise a non-woven scrim. The non-woven scrim may comprise an upper surface opposite a lower surface. The lower surface of the non-woven scrim may be positioned immediately adjacent to and in direct contact with the first major surface 121 of the body 120. The face coating 210 may be applied to the non-woven scrim such that the lower surface 212 of the face coating 210 is in direct contact with the upper surface of the non-woven scrim.

The surface coating 200 may be formed by applying a coating composition in the wet-state having a solids content ranging from about 60 wt. % to about 75 wt. %—including all amounts and sub-ranges there-between. In some embodiments, the surface coating 200 may be formed by applying a coating composition in the wet-state having a solids content ranging from about 60 wt. % to about 70 wt. %—including all amounts and sub-ranges there-between. The coating composition in the wet-state has a high-solid's content. According to the present invention, the term “high solids content” refers to a solids content of at least about 65 wt. % based on the total weight of the edge coating composition. Stated otherwise, the liquid carrier is present in a maximum amount of about 35 wt. % based on the total weight of the edge coating composition

The coating composition in the wet-state may comprise binder, the hydrophobic component, pigment, thickener, antimicrobial agent, defoamer, stabilization agent, as well as a liquid carrier. The liquid carrier may be selected from water, VOC solvent—such as acetone, toluene, methyl acetate—or combinations thereof. In a preferred embodiment, the liquid carrier is water and comprises less than 1 wt. % of VOC solvent based on the total weight of the liquid carrier.

The solid's content is calculated as the fraction of materials present in the coating composition that is not the liquid carrier. Specifically, the solid's content of the coating composition may be calculated as the amount of binder, hydrophobic component, pigment, thickener, antimicrobial agent, defoamer, stabilization agent, in the coating composition and dividing it by the total weight of the edge coating composition (including liquid carrier).

Therefore, the amount of each component in the coating composition may be calculated by multiplying the desired amount of each of the binder, hydrophobic component, and pigment. (as well as other additives, such as dispersant and/or wetting agent) present in the surface coating 200 in the dry-state by the total solids content of the edge coating composition. For example, for a surface coating 200 in the dry-state comprising about 68.0 wt. % of pigment, whereby that surface coating 200 is formed from an coating composition having a solids content of 70.0 wt. %—the amount of the pigment in the edge coating composition would be 47.6 wt. % based on the total weight of the edge coating composition in the wet-state—i.e., 68.0 wt. %×0.7=47.6 wt. % of pigment in the coating composition (wet-state).

Depending on the solid's content of the coating composition (i.e., wet-state), the coating composition may be applied to the first major surface 121 of the body 120 in an amount ranging from about 15 g/m² to about 22 g/m—including all sub-ranges and values there-between. Depending on the solid's content of the coating composition (i.e., wet-state), the coating composition, the coating composition (i.e., wet-state) may be applied to the first major surface 121 of the body 120 in an amount ranging from about 17 g/m² to about 21 g/m²—including all sub-ranges and values there-between. The coating composition may be applied to the first major surface 121 of the body 120 by spray, dip, roll, wheel coater.

Once applied, the coating composition may be dried at a drying temperature for a drying period. The drying temperature is the temperature as measured at the surface of the coating composition on the body 120. The drying temperature may be greater than the melting temperature of the hydrophobic component. The coating composition in the wet state may be applied to the body 120 in a continuous manner and once dried may form the discontinuous coating 200.

The drying temperature may range from about 100° C. to about 140° C.—including all sub-ranges and temperature there-between—as measured at the surface of the coating composition applied to the body 120.

The surface coating 200 applied to the body 120 in the dry-state may occupy an overall volume, which may be referred to as a “first volume.” The first volume is calculated as the total volume of all solid components present in the surface coating 200 (i.e., binder, hydrophobic component, pigment, thickener, antimicrobial agents, stabilization agents, etc.). A second volume of the surface coating 200 may be calculated by the volume occupied by only the pigment within the surface coating 200.

A pigment volume concentration (“PVC”) may be calculated by dividing the second volume of the pigment by the first volume of the overall surface coating 200 in the dry-state—thereby producing a percentage of the volume of the surface coating 200 that is occupied by the pigment. According to the present invention, the PVC of the surface coating 200 may range from about 55% to about 75%—including all percentages and sub-ranges there-between. In some embodiments, the PVC of the surface coating 200 may range from about 55% to about 70%—including all percentages and sub-ranges there-between. In some embodiments, the PVC of the surface coating 200 may range from about 65% to about 70%—including all percentages and sub-ranges there-between.

The surface coating 200 may further comprise a weight ratio of the pigment to binder that ranges from about 3.5:1.0 to about 6.5:1.0—including all ratios and sub-ranges there-between. In some embodiments, the surface coating 200 may further comprise a weight ratio of the pigment to binder that ranges from about 4:1 to about 6:1—including all ratios and sub-ranges there-between. In some embodiments, the surface coating 200 may further comprise a weight ratio of the pigment to binder that is about 4.5:1. In some embodiments, the surface coating 200 may further comprise a weight ratio of the pigment to binder that is about 5:1. In some embodiments, the surface coating 200 may further comprise a weight ratio of the pigment to binder that is about 5.5:1.

It has been discovered that the combination of the hydrophobic component, the binder, and the pigment—whereby the pigment is present in an amount that falls within either the aforementioned PVC range and/or pigment to binder weight ratio range—results in the surface coating 200 exhibiting washing and scrubbing performance that allows the building panel 100 to be continually cleaned from an accumulated dirt or unwanted smudges while also surprisingly not sacrificing the discontinuous nature of the surface coating 200 and maintaining airflow characteristics necessary for the surface coating 200 to exhibit the previously discussed airflow resistance ranges. Stated otherwise, using the pigment in an amount that falls within the aforementioned PVC range and/or pigment to binder weight ratio range along with a hydrophobic component surprisingly results in a surface coating 200 that can function as an acoustically transparent coating for an acoustic building panel 100 while also being capable of being washed clean when dirty.

It has also been discovered that the combination of the hydrophobic component, the binder, and the pigment—whereby the pigment is present in an amount that falls within either the aforementioned PVC range and/or pigment to binder weight ratio range—results in the surface coating 200 having a greater concentration of the hydrophobic component present on or immediate adjacent to the upper surface 211 of the surface coating 200 due to the fact that, at higher drying temperatures, the hydrophobic component may melt and flow to the upper surface 211, whereby it recrystallizes during cooling—thereby further enhancing the cleanability of the resulting building panel 100.

The invention will be described in greater detail by way of specific examples. The following examples are offered for illustrative purposes and are not intended to limit the invention in any manner.

### Examples

A first set of experiments were prepared to test the impact of pigment content within the surface coating. The experiments provided herein use the following components:

The binder (“Binder”) is carboxylated polyvinyl acetate—anionic in nature having a pH of 7 and a Tg of 37° C.

First Pigment (“Pigment 1”) is a blend of non-white color pigments including black, red, and yellow pigments.

Second Pigment (“Pigment 2”) is a blend of white color pigments including TiO₂, CaCO₃, aluminum and trihydrate.

The hydrophobic Component (“HC”) is an anionic wax having a melting temperature of 60° C. and a pH between 9.5 and 10.3—the wax specifically being a blend of paraffin and high density polyethylene (“HDPE”) wax.

The thickener (“Thickener”) is non-ionic hydroxyl ethylene cellulose. The dispersant (“Dispersant”) is an anionic compound.

The defoamer includes a silicone-containing compound.

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Binder | 22.5% | 15.4% | 15.3% | 32.7% | 30.8% | 10.4% |
| Pigment 1 | 1.2% | 1.8% | 1.8% | 1.2% | 1.3% | — |
| Pigment 2 | 64.9% | 75.0% | 74.5% | 57.0% | 58.6% | 84.0% |
| HC | 2.7% | 4.1% | 4.7% | 2.9% | 3.0% | 3.9% |
| Thickener | 0.1% | 0.1% | 0.1% | 0.1% | 0.1% | 0.4% |
| Dispersant | 0.4% | 0.5% | 0.5% | 0.5% | 0.5% | 0.7% |
| Biocides | 8.1% | 3.0% | 3.0% | 5.5% | 5.6% | 0.6% |
| Defoamer | 0.1% | 0.1% | 0.1% | 0.1% | 0.1% | 0.9% |
| Total Solids | 100% | 100% | 100% | 100% | 100% | 100% |
| Pigment | 56.7% | 67.3% | 67.1% | 43.5% | 45.6% | 74.8% |
| Volume | | | | | | |
| Concentration | | | | | | |
| Pigment to | 3.24:1 | 5.02:1 | 5.0:1 | 1.9:1 | 2.0:1 | 8.09:1 |
| Binder Ratio | | | | | | |

Liquid carrier was added to each formulation and each of the resulting wet-state coating compositions were applied to a body and dried at a drying temperature—as measured at the surface of the coating composition on the body 120—between 100° C. to about 140° C. Subsequently each coating was evaluated for the appearance of blistering & cracking, color L, a, b, Y values, gloss, water repellency, washability, and scrubability—the evaluation values are set forth below in Table 2.

TABLE 2

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Blistering | Pass | Pass | Pass | Fail | Fail | Pass |
| Cracking | Pass | Pass | Pass | Fail | Fail | Pass |
| Color - Black | | | | | | |
| L | 28.03 | 22.67 | 22.30 | 27.17 | 27.38 | — |
| a | 0.46 | 0.09 | 0.11 | 0.43 | 0.17 | — |
| b | −0.67 | −0.59 | −0.50 | −0.46 | −0.97 | — |
| Y | 5.4 | 3.70 | 3.60 | 5.48 | 5.39 | — |
| Color - White | | | | | | |
| L | 27.99 | 22.70 | 22.37 | 26.95 | 27.09 | 96.6 |
| a | 0.51 | 0.10 | 0.09 | 0.44 | 0.17 | — |
| b | −0.60 | −0.59 | −0.57 | −0.49 | −0.98 | 2.15 |
| Y | 5.4 | 3.71 | 3.61 | 5.29 | 5.21 | — |
| Gloss | | | | | | |
| 20° | 0.0 | 0.0 | 0.0 | 0.2 | 0.1 | — |
| 60° | 0.7 | 0.4 | 0.4 | 2.0 | 1.2 | — |
| 85° | 2.6 | 3.2 | 2.9 | 4.2 | 2.3 | — |
| Water Repellency | Fail | Pass | Pass | Fail | Pass | Pass |
| Wash Test | Pass | Pass | Pass | Pass | Pass | Pass |
| Scrub Test | Pass | Pass | Pass | Fail | Fail | Pass |

As demonstrated by Table 2, the coating composition of the present invention surprisingly exhibited superior cleanability without sacrifice of the desired aesthetic characteristics. Specifically, the coated building panels of Examples 2 and 3 each passed the water repellency test, wash test, and scrub test while exhibiting the black color, white color, and gloss values needed for application to an acoustical building panel—as compared to the coated building panels of Comparative Examples 1 and 2, which each failed the scrub test and Comparative Example 1 further failing the water repellency test.

While the building panel of Example 1 failed the water repellency test, it still passed each of the wash test and the scrub test while also exhibiting a 0.0 gloss value at 20°, <1.0 gloss value at 60°, and <4.0 gloss value at 85°. While the coated building panel of panel of Comparative Example 3 exhibited a passing grade for water repellency, wash test, and scrub test, this coated building panel failed to yield gloss values or any non-white color values as the non-white pigment could not be incorporated into the coating formulation at such high such a pigment to binder ratio.

1. A coated building panel comprising:
an acoustical body comprising a first major surface and a side surface that intersects the first major surface;
a coating applied to the first major surface, the coating comprising:
a polymeric binder;
a pigment; and
a hydrophobic component present in an amount ranging from about 1.0 wt. % to about 8.0 wt. % based on the total weight of the coating; and
wherein the pigment and polymeric binder are present in a weight ratio ranging from about 3.5:1 to about 6.5:1.

2. The coated building panel according to claim 1, wherein the hydrophobic component comprises a wax.

3. The coated building panel according to claim 2, wherein the wax is a blend of paraffin wax and HDPE wax.

4. The coated building panel according to claim 1, wherein the hydrophobic component has a melting point between about 50° C. and about 70° C.

5. The coated building panel according to claim 1, wherein the polymeric binder has a Tg of at least about 20° C.

6. The coated building panel according to claim 1, wherein the polymeric binder is polyvinyl acetate.

7. The coated building panel according to claim 1, wherein the polymeric binder has a pH ranging from about 6.5 to about 7.5.

8. The coated building panel according to claim 1, wherein the polymeric binder is present in an amount ranging from about 10.0 wt. % to about 30.0 wt. % based on the total weight of the coating.

9.-49. (canceled)

50. A coated building panel comprising:
an acoustical body comprising a first major surface and a side surface that intersects the first major surface;
a coating applied to the first major surface, the coating comprising:
a polymeric binder;
a surfactant;
a hydrophobic component;
a pigment composition comprising a first pigment having a non-white color; and
wherein the coating occupies a first volume, and the pigment composition occupies a second volume that is equal to about 51% to about 78% of the first volume, and wherein the surfactant and the first pigment are present in a weight ratio ranging from about 3:1 to about 1:3.

51. The coated building panel according to claim 50, wherein the second volume is equal to about 52% to about 60% of the first volume.

52. The coated building panel according to claim 50, wherein the hydrophobic component comprises a wax.

53. The coated building panel according to claim 52, wherein the wax is a blend of paraffin wax and HDPE wax.

54. The coated building panel according to claim 50, wherein the hydrophobic component is present in an amount ranging from about 1.0 wt. % to about 8.0 wt. % based on the total weight of the coating.

55. The coated building panel according to claim 50, wherein the hydrophobic component has a melting point between about 50° C. and about 70° C.

56. The coated building panel according to claim 50, wherein the polymeric binder is polyvinyl acetate.

57. (canceled)

58. The coated building panel according to claim 50, wherein the surfactant is an anionic surfactant.

59. The coated building panel according to claim 50, wherein the surfactant is present in an amount ranging from about 0.1 wt. % to about 2.0 wt. % based on the total weight of the coating.

60.-83. (canceled)

84. A coating composition comprising:
a liquid carrier;
a solid blend comprising:
a polymeric binder having a Tg of at least about 20° C.;
a pigment; and
a hydrophobic component; and
wherein the solid blend occupies a first volume, and the pigment occupies a second volume that is equal to about 51% to about 78% of the first volume.

85. The coating composition according to claim 84, wherein the hydrophobic component comprises a wax, wherein the wax is a blend of paraffin wax and HDPE wax.

86.-87. (canceled)

88. The coating composition according to any one of claims 84 to 87, wherein the polymeric binder is polyvinyl acetate and has a pH ranging from about 6.5 to about 7.5.

89.-96. (canceled)

77.-95. (canceled)
